(19) United States
(12) Patent Application Publication
(10) Pub. No.: US 2009/0096225 A1
(43) Pub. Date: Apr. 16, 2009

(54) DEVICE AND METHOD FOR REMOVING FECAL MATTER

(76) Inventor: Monte G. Ashworth, Salt Lake City, UT (US)

Correspondence Address: TERRENCE J. EDWARDS;CLAYTON, HOWARTH & CANNON, P.C., P.O. BOX 1909, SANDY, UT, 84091, US

(21) Appl. No.: 11/961,416

(22) Filed: Dec. 20, 2007

Related U.S. Application Data
(60) Provisional application No. 60/999,165, filed on Oct. 16, 2007.

(51) Int. Cl. A01K 29/00

(52) U.S. Cl. 294/1.3

(57) ABSTRACT

An animal waste removal device and method is disclosed. The device may include a plurality of extension pieces each having a point at its terminal end and a protruding wall acting as a finger or thumb guard. The device is designed to work in any position, in any condition, and on any surface. In particular, the device is designed to pick-up, scoop, scrape, spear or poke animal waste without leaving substantial animal waste residue.

### CROSS-REFERENCE TO RELATED APPLICATIONS

This application claims the benefit of U.S. Provisional Application No. 60/999,165, filed Oct. 16, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The present disclosure relates generally to devices and methods for collecting and removing animal waste, and more particularly, but not necessarily entirely, to a portable device for collecting and removing animal waste.

2. Description of Related Art

It has been estimated that the United States human population is outnumbered by their pets. That estimation is likely true in other countries around the world as well. The total population of cats and dogs in the United States is estimated at about 163 million, which is more than one cat or dog for every two people. As these numbers increase, the public demand for animal regulation increases in a corresponding manner, responsive to the public health and safety concerns related to the relatively high numbers of pet animals. For example, in an effort to control the pet population, some municipalities are requiring male pets to be neutered and female pets to be spayed or otherwise quarantined when in heat.

In many municipal regions, pet owners are subject to ordinances requiring animals be leashed at all times in public, and restrained in private to prevent uncontrolled wandering. As a result of the large number of pets, some municipalities have promulgated so-called “pooper-scooper” ordinances, which require pet owners to accept personal responsibility for collection and disposal of the waste material produced by their pet animals. A typical ordinance requires a pet owner, in order to avoid criminal charges, to immediately place the waste in a plastic bag, securely tied, or other container and then place it in a solid waste or garbage container. The enforcement of some ordinances includes fines, jail time, and probation as penalties for a violation of the ordinance.

When pet owners are subject to both leash-laws and pooper-scooper ordinances, the owner is required to: (1) “walk” their pet on a leash; and (2) retrieve and dispose of pet waste when and where the animal decides to relieve itself. This distasteful routine is familiar to all responsible dog owners and many bystanders. Because of the distastefulness of this routine, many less responsible dog owners leave their pet's waste where it lies. A local legislative body may respond to this problem by instituting severe sanctions for such behavior, such as the type of penalties exemplified above. Devices that are currently used in the marketplace attempt to respond to the above stated problem by proposing means designed to minimize the unpleasantness of the gathering and disposal of such animal waste.

For instance, the term “pooper-scooper” originally denominated a long-handled mechanical apparatus, which has been used in the marketplace for years. Such a traditional pooper-scooper is used for retrieving dog wastes without soiling the owners'hands. Unfortunately, such pooper-scoopers are often large and awkwardly-configured devices that are not easily portable and are often soiled during use. Other versions and designs of pooper-scoopers include a rigid tray or scoop provided on an end of an elongated handle to scoop up the waste material as best as possible. This design often smears the waste on the grass or ground, which is disadvantageous when at a park or a pet owner's home, and the tray or scoop itself is often soiled and difficult to clean. Further, such designs and others often require use of both hands, which is extremely difficult when holding a pet's leash.

Even if a disposable bag is placed within the tray, no means are provided for cleanly gathering all of the waste material into the bag. This omission usually requires a pet owner to employ a twig, branch, or other readily-available item as a tool or scraper for manipulating the waste material from its lie into the bag.

Accordingly, pet owners are often confronted with pet waste that can be collected using only an awkward scoop or shovel or, worse, a simple plastic bag for use together with whatever other “tools” may be afforded by their immediate environment. Human nature being what it is, such unpleasant pet waste is commonly left where it lies, creating social, public-health, and legal problems for the pet owner and others. Other solutions in the market such as, but not limited to, disposable surgical gloves, paper towels or tissues, sandwich bags and the like do little to reduce the well-known unpleasantness of the pet sanitation task. None of these alternatives provides for simple sanitary gathering and removal of pet waste.

Further, the waste pick-up device should be convenient to carry and easy to operate. Devices that require simultaneous use of both hands presents a problem with respect to retention of the pet leash. If the waste pick-up device requires two hands for use the leash must be put down, which is undesirable since the pet may run away, slipping of the leash onto a wrist, which is undesirable as retention of the leash is difficult and operation of the waste pick-up device is considerably hindered.

Accordingly, there is a need for an animal waste collection device that is easy to operate, i.e., needs only one hand to operate, is not awkward to use and does not readily smear pet waste, thereby avoiding the general distastefulness associated with the smell of animal waste when it is smeared. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a top view of an animal waste collection device made in accordance with the principles of the present disclosure;

FIG. 1A is an enlarged partial top view of the animal waste collection device of FIG. 1 particularly illustrating the details of a plurality of extension pieces of the device;

FIG. 2 is a perspective view of an animal waste collection device made in accordance with the principles of the present disclosure;

FIG. 3 is another top view of an animal waste collection device in a grassy area and made in accordance with the principles of the present disclosure;

FIGS. 4-6 are top views of the animal waste collection device during use and taken sequentially in a step-by-step process;

FIGS. 7-8 are top, perspective views of the animal waste collection device shown picking up mushy or wet waste;

FIG. 9 is a top, perspective view of the animal waste collection device illustrated as poking or stabbing dry animal waste;

FIG. 10 is a perspective view of the animal waste collection device being cleaned using a simple plastic bag;

FIG. 11 is a detailed perspective, side view of the extension pieces of the device made in accordance with the principles of the present disclosure;

FIG. 12 is a side view of the animal waste collection device used in an inclined position with respect to a hardened surface of a strike material and made in accordance with the principles of the present disclosure;

FIG. 13A is a schematic front view of the animal waste collection device having linear, flat extension pieces so as to form a substantially flat collection area; and

FIG. 13B is a schematic front view of the animal waste collection device having extension pieces that are curved so as to form a substantially curved collection area.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present structural features of the animal or pet waste removal or collection device and methods for using the same are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

In describing and claiming the present disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the term “proximal” shall refer broadly to the concept of a nearest portion. For example, the location where a user grasps the device is the proximal-most portion of the pet waste removal device, because it is the portion nearest to the user when said device is being used.

As used herein, the term “distal” shall generally refer to the opposite of proximal. Thus, “distal” refers to the location opposite of where a user grasps the device, such that the distal-most portion of the pet waste removal device is the portion farthest away from the user when said device is being used or held.

As used herein, the phrase “in an at least partially proximal-to-distal direction” shall refer generally to a two-dimensional concept of direction in which the “proximal-to-distal” direction defines one direction or dimension. An item that extends in a non-parallel direction with respect to the “proximal-to-distal” direction, that is, at an angle between zero and one-hundred and eighty degrees, thereby involves two components of direction, one of which is in the “proximal-to-distal” direction and the other being in a direction orthogonal to the “proximal-to-distal” direction.

As used herein, the phrase “animal waste” refers broadly to fecal material that is expelled from the intestinal tract of any animal in the biological classification kingdom known as Animalia, which includes humans as part of the class Mammalia, that can be removed using the device disclosed herein.

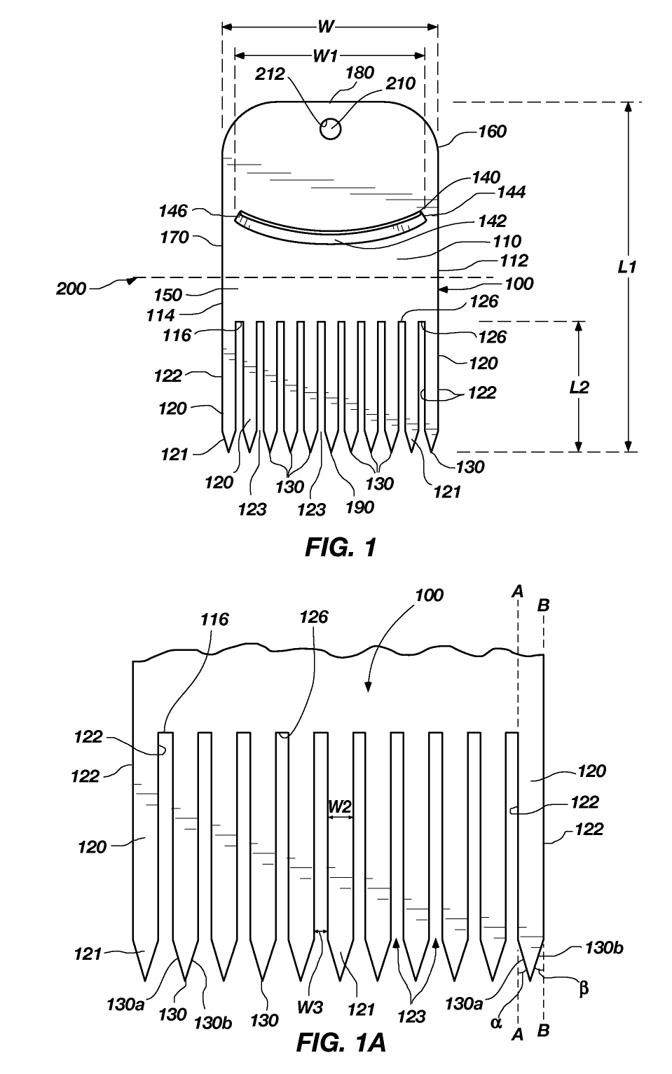

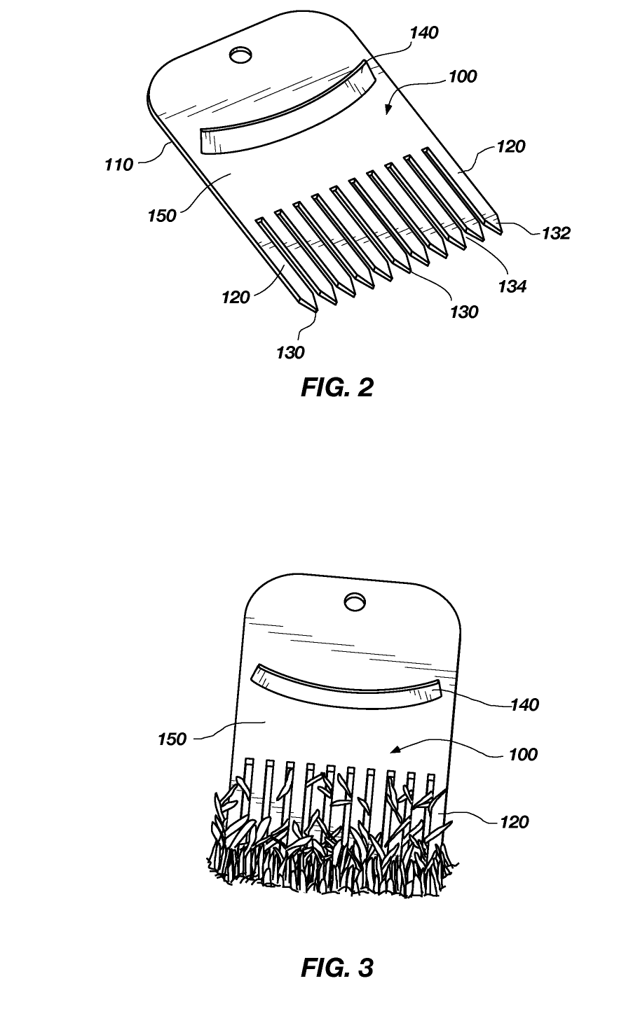

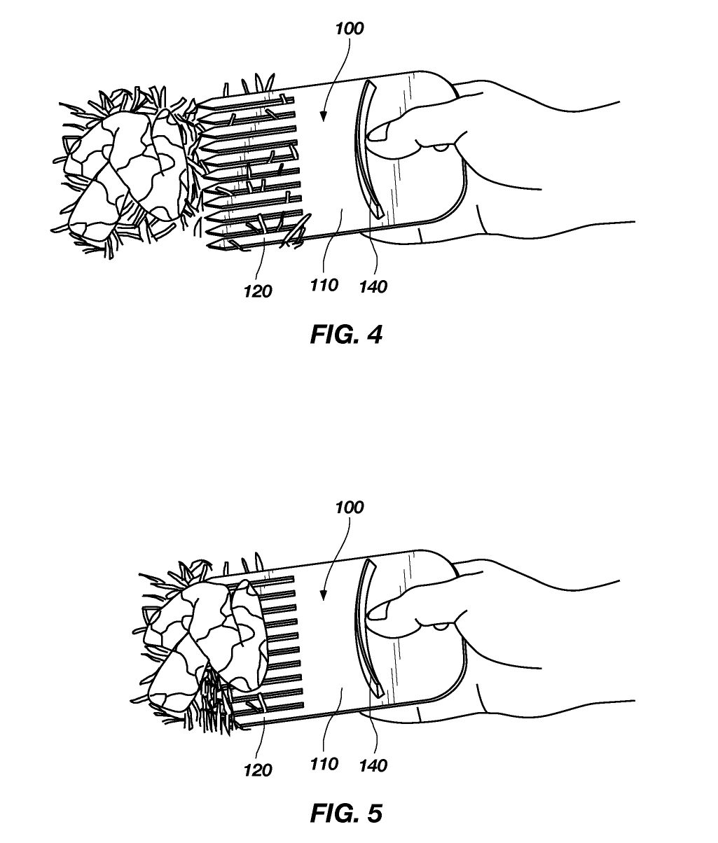

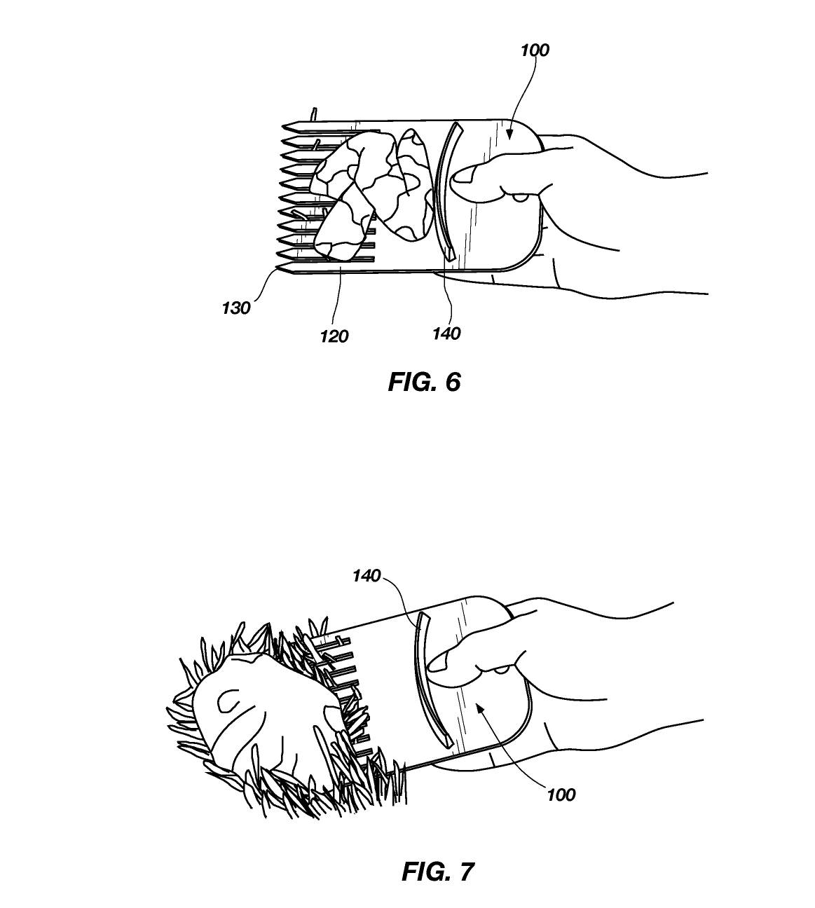

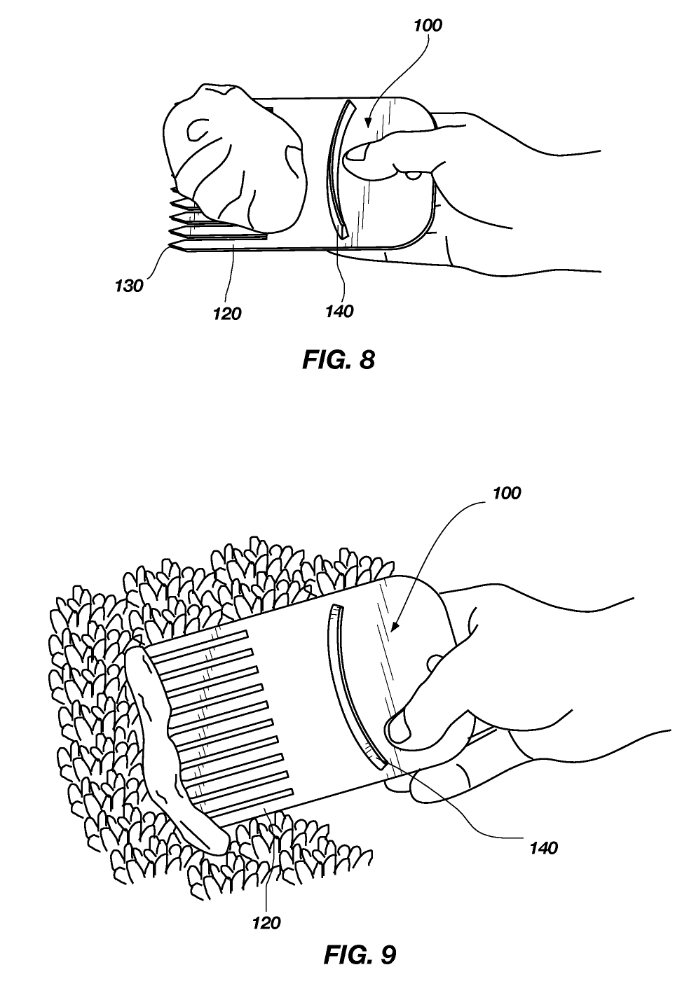

Referring now to FIGS. 1-11 the animal or pet waste collection and removal device 100 of the present disclosure may comprise many features that make cleaning or picking up animal waste a much easier job and a more pleasant experience for a user. The animal waste removal device 100 may be used in any position or angle of incline. For example, the device 100 may be used in a completely horizontal manner or a completely vertical manner, on its side or edge, or at an angle of incline, depending upon the clean-up job required. For example, in a grassy area or on a carpeted area the device 100 may be used in a substantially horizontal manner such that the device 100 may be located beneath the animal waste located on the grass or carpet in a substantially horizontal manner or at a slight an angle of inclination. As the device 100 is subsequently raised up through the grass or carpet, the device 100 may lift the animal waste cleanly from the grass.

In another application, the device 100 may be used advantageously around shrubs, bushes, trees, flowers or other flora, vegetation or plant life where an animal has deposited waste. For example, the device 100 may be advantageously used to poke, jab or stab animal waste using the device 100 as detailed herein below to cleanly remove the animal waste. In another application, the device 100 may be used on concrete or other hard surface having a substantially flat surface. In such an application, the device 100 may be turned on its side and its side or edge may be used to scrape the concrete or other hardened surface, thereby cleanly removing the animal waste.

It will be appreciated that the device 100 may be manufactured from any polymeric material that is capable of being used in an injection mold. For example, thermoplastics may be used effectively as the material for the device 100, since thermoplastic materials soften upon heating and harden upon cooling. The device 100 may be manufactured using a single cavity mold, a double cavity mold or other method during the injection molding process.

To cleanly remove animal waste, the device 100 may include the following advantageous features: a substantially flat base 110 having a proximal end 180, a distal end 190 and a medial side 160 and a lateral side 170 and comprising a plurality of extension pieces 120 each having a point 130 at its terminal end. As used herein, the term “point” refers to a substantial V-shaped object at least in one plane. Further, the point 130 may have a sharp end at the apex of the V-shape or the point 130 may be rounded at the apex of the V-shape, without departing from the spirit or scope of the present disclosure. The medial side 160 and the lateral side 170 may each comprise an edge 112 and 114, respectively, that defines the medial-lateral limits of the device 100. Further, it will be appreciated that the edges 112, 114 may be substantially square to permit the device 100 to be used as a scraper.

The device 100 may further include a protruding wall 140 located on a top side or upper surface 150, or alternatively on a bottom side or bottom surface 162 of the device 100, or alternatively on both sides of the device 100. The wall 140, no matter its position on the top or bottom side or both, may operate as a finger or thumb guard to ensure that there is no contact with the animal waste with a user's hand. The protruding wall 140 may be placed on the proximal side 180 of a mid-line 200 of the device 100. The protruding wall 140 may operate as a barrier to reduce the likelihood that a user's hand will contact the animal waste. A plane may be defined by the top side or upper surface 150 of the device 100 and the wall 140 may protrude in a substantially perpendicular manner with respect to the plane defined by the upper surface 150.

It will be appreciated that the protruding wall 140 may extend from the medial side 160 to the lateral side 170 and may extend over a majority width “W” of the device 100. More specifically, the protruding wall 140 may have a width “W1” and may extend in the medial to lateral direction within a range of about fifty to about ninety-five percent of the width “W” of the device 100.

It will be appreciated that in one embodiment the protruding wall 140 may be curved, such that an apex 142 of wall 140 may lie distally with respect to each end 144, 146 of the wall 140. In the curved wall 140, the curve may follow an arcuate path that follows the natural grip of a user's hand, such that there is a barrier between the user's hand and the animal waste regardless of how the user's grips the device. Further, regardless of whether or not the wall 140 is curved, the wall 140 may extend upwardly from the upper surface 150 and may comprise a height, measured with respect to said upper surface 150, that is within a range of about six millimeters to about sixteen millimeters. It will be appreciated that all other dimensions within that range fall directly within the scope of the present disclosure. The height of the wall 140 may be advantageous to protect a user's hand from contact with animal waste.

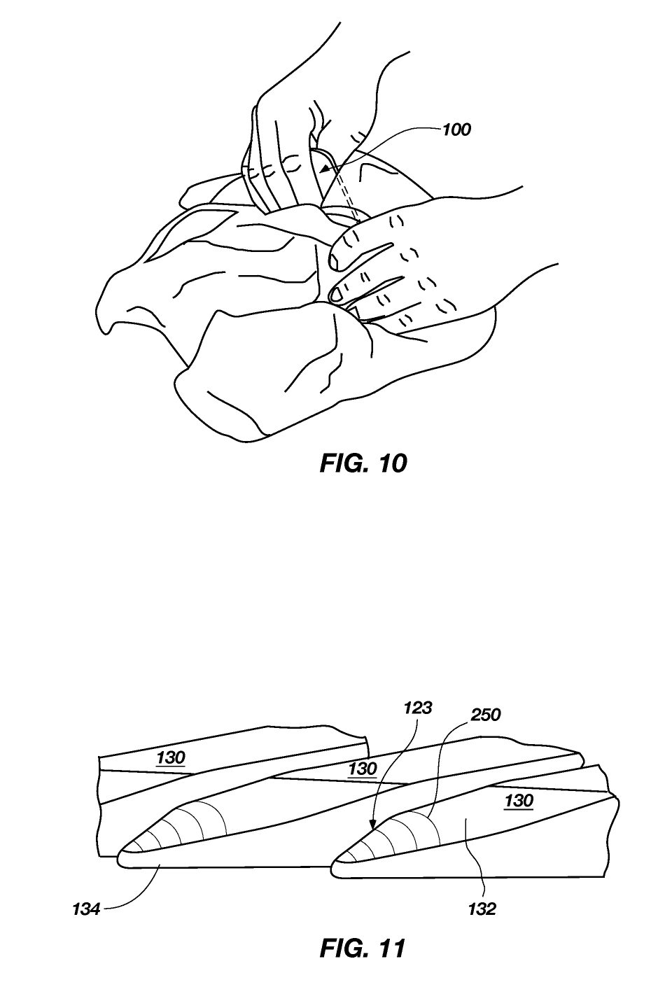

It will be appreciated that the substantially flat base 110, also referred to herein as a substantially flat body portion 110, may allow the device 100 to be easily cleaned by dragging the device 100 over and through grass or dirt, for example. The flat shape of the device 100 may also aid in cleaning the device 100 by insertion into a plastic bag and pulling the device 100 as the bag is snugly held, thereby removing animal waste from the device 100 (illustrated best in FIG. 10).

It will be appreciated that the flat base 110 and the extension pieces 120 may be modified to include a slight bow or curvature in a medial 160 to lateral 170 direction (as opposed to a proximal 180 to distal 190 direction) of the device 100 in the area that is located at and distally with respect to the midline 200 to form a substantially curved collection area (the slight bow is illustrated schematically in FIG. 13B and is compared to a substantially flat base in FIG. 13A). The substantially flat base 110 may include square edges 112 and 114 on the medial and lateral sides 160 and 170. The square edges 112, 114 permit the device 100 to scrape hardened surfaces, thereby eliminating a majority of the animal waste from the hardened surface.

A hole 210 defined by a sidewall 212 may be formed in the substantially flat base 110. The hole 210 may be used as a means to store or display the device 100 on a hanger, for example, which may serve as a tension member used to suspend another member, i.e. the device 100.

It will be appreciated that the plurality of extension pieces 120 may extend outwardly from the substantially flat base 110 in a distal direction. More specifically, the plurality of extension pieces 120 may extend distally from an end 116 of the substantially flat base 110. Applicant has found eleven extension pieces 120 to be an advantageous number, although it will be appreciated that more or less extension pieces 120 may be utilized by the present disclosure.

As illustrated best in FIG. 1, each of the plurality of extension pieces 120 may have a length “L2” that may have a value between a range of about twenty percent to about sixty percent of a length “L1” of the entire device 100. For example, the length “L2” of each extension piece 120 may be about forty millimeters to about seventy-five millimeters. Applicant has found extension pieces 120 that may be about sixty millimeters in length “L2” to be advantageous. Further, as illustrated best in FIG. 1A, the plurality of extension pieces 120 may each comprise a width “W2” that may have a value between a range of about three millimeters to about eight millimeters and may advantageously be about six millimeters.

In comparison, the outer dimensions of the device 100 may be about one-hundred and twenty-five millimeters to about two-hundred millimeters (i.e., about 5 to about 8 inches) in length and about seventy-five millimeters to about one-hundred and twenty-five millimeters (i.e., about 3 to about 5 inches) in width. Applicant has found that an advantageous size of the device 100 to be about 6.5 inches in length and about 4 inches in width. The above dimensions have been found to be small enough for portability as well as large enough to handle any size animal waste deposit. However, it will be appreciated that other dimensions may be used to manufacture the device 100 without departing from the spirit or scope of the present disclosure.

The point 130 may be located at and may extend from a free end 121 of each extension piece 120 in an outward manner. A slot, space or gap 123 may be formed between each extension piece 120. In other words, the plurality of extension pieces 120 may be separated from each other so as to provide the slot, space or gap 123 therebetween, as illustrated in FIG. 1.

As illustrated best in FIG. 11, each point 130 may be rounded at its end, or may include a rounded tip, to aid in guiding strike material through the gaps 123 of the device 100. Further, the rounded end or tip of the point 130 may be advantageous in the removal of waste material and may reduce the likelihood of injury to a user by contact with the tip. The round tip may also reduce the possibility of the tip penetrating or hanging up on the strike material causing the device 100 to jerk as it is moved through the strike material. Further, the round tip may serve to guide the strike material through the slots, spaces and gaps 123, thereby aiding in locating the animal waste on the top surface 150 of the device 100. As used herein, the term “strike material” refers to grass, carpet, dirt, ground cover or other similar areas, and the term also refers to hardened surfaces, such as wood, tile or concrete surfaces or any other surface upon which the device 100 may move.

As illustrated best in FIG. 1A, each point 130 may comprise a first surface 130a and a second surface 130b that may both be angled (see angles α and β, respectively in FIG. 1A). The first surface 130a and the second surface 130b may form angles α and β, respectively, with respect to an imaginary line (illustrated as lines A-A and B-B in FIG. 1A) that may run parallel to one of the edges 122 defining one of the extension pieces 120. The angles α and β may both be substantially the same and may be formed within a range of about ten degrees to about twenty-five degrees, and all angles between that range are included within the scope of the present disclosure. It will be appreciated that the angles α and β do not necessarily have to be the same or substantially the same, however, for symmetrical purposes it may be advantageous.

It will be appreciated that a width of each slot, space or gap 123 may be designed to allow strike material to easily pass through the extension pieces 120. It will be appreciated that the slots, spaces or gaps 123 should not be too wide or else mushy or wet animal waste may easily escape or drip through the extension pieces 120. It has been found that an appropriate and advantageous width of the gap “W3,” e.g., the distance between adjacent extension pieces 120, may be within a range of about two millimeters to about five millimeters, and advantageously about three millimeters. Other widths may also be used by the present disclosure, however, it should be noted that widths wider than about five millimeters may encounter problems maintaining the animal waste on the extension pieces 120. As illustrated best in FIG. 1A, it will be appreciated that the gap width “W3” may be within a range of about twenty-five percent to about sixty-seven percent of the width “W2” of each of the plurality of extension pieces 120. The width “W2” of the extension pieces 120 may become important when removing mushy or wet animal waste to ensure that such mushy or wet waste does not drip in between adjacent extension pieces 120. However, it should be noted that there must be enough of a gap 23 or a wide enough gap 123 between adjacent extension pieces 120 to allow strike material to pass through easily without hanging up.

Further, back edge 126 may be formed between two adjacent extension pieces 120 at a junction of each slot, space or gap 123 with the end 116 of the substantially flat base 110, i.e., in between where the extension pieces 120 extend from the base 110. The back edge 126 may be beveled, which may aid in preventing the strike material from clogging up or being caught up on the device 100. In other words, the beveled back edge 126 may allow the strike material to move through the gap 123 more easily without clogging.

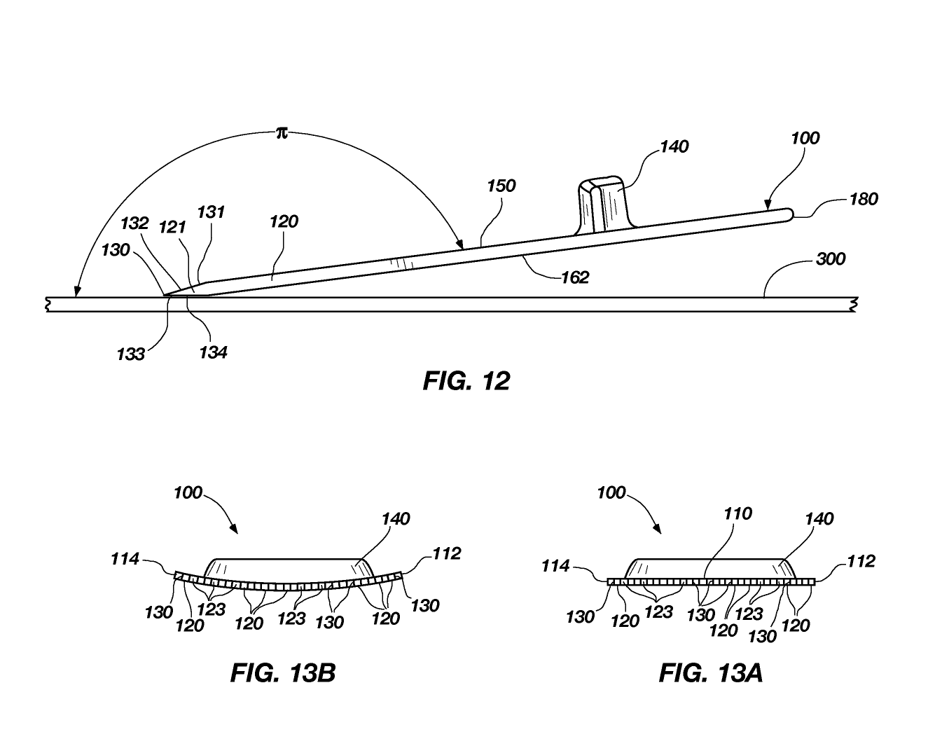

As illustrated best in FIGS. 11-12, each point 130 may include a top side 131 that may be beveled, which may be a top tapered surface 132, and a bottom side 133 that may be beveled, which may be a bottom tapered surface 134, as illustrated best in FIGS. 11 and 12. Both the top tapered surface 132 and the bottom tapered surface 134 of each point 130 may help to reduce friction between the point 130 and the strike material, to thereby aid in removing the animal waste. The beveling of the surfaces 132, 134 may cause the plurality of extension pieces 120 to flatten out distally as the device 100 nears a tangential orientation with respect to the strike material.

The bottom tapered surface 134 may also aid in maintaining the device 100 and particularly the extension pieces 120 in a substantially flat orientation on hardened surfaces, such as wood, tile or concrete, even though the device itself may be inclined to a degree and may further prevent the device 100 from bouncing or hanging up on the strike material. As illustrated best in FIG. 12, the device 100 may be advantageously used in an inclined manner with respect to strike material having hardened surfaces. When inclined on hardened surfaces the device 100 may form an obtuse angle n with the hardened surface 300.

Further, the beveled or tapered top and bottom surfaces 132 and 134 of each point 130 may comprise a plurality of ribs 250, which may be raised edges or textured surfaces, to help prevent the animal waste from falling off the points 130 or the extension pieces 120. The ribs 250 may be especially advantageous when poking or spearing animal waste.

Finally, it will be appreciated that each of the extension pieces 120 may comprise an edge 122 on each side of the extension piece 120. The edge 122 may be square or squared off, which may aid in preventing mushy or wet animal waste from falling in between the extension pieces 120. However, it will be appreciated that other shapes of the edges 122 may be used without departing from the spirit or scope of the present disclosure. For example, a rounded or bull nose edge 122 may be used or other shapes that are known in the art may be used without departing from the scope of the present disclosure. Applicant has found, however, that the squared off edge 122 is an advantageous shape for the intended purpose of the edge 122 of the extension piece 120.

Thus, it will be appreciated that the structure and apparatus disclosed herein may be designed to work in any position, whether substantially horizontal or flat, inclined, or vertical and may be used in any condition where an animal or pet has deposited its waste. Further, the structure and apparatus disclosed herein may operate and function effectively on any strike material or surface, such as grass, dirt, carpet, wood, tile, concrete, ground cover, or other surfaces. The structure and apparatus disclosed herein may be designed to cleanly pick-up and remove animal waste through scooping, scraping, spearing, poking or otherwise removing animal waste without smearing or leaving substantial animal waste residue.

It will be appreciated that the structure and apparatus disclosed herein is merely one example of a means for positioning animal waste on the device, and it should be appreciated that any structure, apparatus or system for positioning animal waste with respect to a device that performs functions the same as, or equivalent to, those disclosed herein are intended to fall within the scope of a means for positioning animal waste, including those structures, apparatus or systems for positioning animal waste that are presently known, or which may become available in the future. Anything which functions the same as, or equivalently to, a means for positioning animal waste with respect to a device falls within the scope of this element.

It will be appreciated that the structure and apparatus disclosed herein is merely one example of a means for maintaining animal waste on the device, and it should be appreciated that any structure, apparatus or system for maintaining animal waste on a device that performs functions the same as, or equivalent to, those disclosed herein are intended to fall within the scope of a means for maintaining animal waste, including those structures, apparatus or systems for maintaining animal waste that are presently known, or which may become available in the future. Anything which functions the same as, or equivalently to, a means for maintaining animal waste on a device falls within the scope of this element.

In accordance with the features and combinations described above, a useful method of removing animal waste may include the steps of:

(a) providing a device having a plurality of extension pieces each having a point at its terminal end and a protruding wall acting as a guard; and

(b) positioning the device relative to a strike material in preparation for removing animal waste; and

(c) moving the device relative to the animal waste such that the waste is positioned on the plurality of extension pieces.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An animal waste removal device comprising:
a substantially flat body portion;
a plurality of extension pieces extending from the body portion; and
a point located at a terminal end of each of the plurality of extension pieces.

2. The animal waste removal device of claim 1, wherein each of the plurality of extension pieces has a length that is between a range of about twenty percent to about sixty percent of a length of the entire device.

3. The animal waste removal device of claim 1, wherein the device further comprises a wall protruding from the body forming a barrier between a user's hand and animal waste that is to be collected by the device.

4. The animal waste removal device of claim 3, wherein the substantially flat body comprises an upper surface and a lower surface, wherein a plane is defined by the upper surface, and wherein the wall protrudes substantially perpendicular to the plane defined by the upper surface.

5. The animal waste removal device of claim 1, wherein the device further comprises a proximal end, a distal end, a medial side and a lateral side, wherein the medial side comprises a medial edge and the lateral side comprises a lateral edge, wherein the medial edge and the lateral edge define the medial-lateral limits of the device and wherein said medial edge and said lateral edge are square.

6. The animal waste removal device of claim 1, wherein the plurality of extension pieces each comprise a width that is between a range of about three millimeters to about eight millimeters.

7. The animal waste removal device of claim 1, wherein device comprises a gap formed between two adjacent extension pieces and having a width, wherein the width is within a range of about two millimeters to about five millimeters.

8. The animal waste removal device of claim 1, wherein device comprises a gap formed between two adjacent extension pieces and having a width, wherein the width is within a range of about twenty-five percent to about sixty-seven percent of a width of each of the plurality of extension pieces.

9. The animal waste removal device of claim 1, wherein the substantially flat body portion comprises a back edge formed at a junction of a gap formed between two adjacent extension pieces with an end of the substantially flat body portion.

10. The animal waste removal device of claim 9, wherein the back edge is beveled for allowing strike material to move through the gap without clogging.

11. The animal waste removal device of claim 8, wherein each point is rounded to guide strike material through the gaps of the device to aid in the removal of waste material, to reduce the occurrence of injury to a user and to reduce the chance of the points penetrating, thereby hanging up on, the strike material.

12. The animal waste removal device of claim 1, wherein each of the points has a top side that is beveled and a bottom side that is beveled to reduce friction between the plurality of extension pieces and the strike material, to cause the plurality of extension pieces to flatten out as the device nears a tangential orientation with respect to the strike material.

13. The animal waste removal device of claim 12, wherein an obtuse angle is formed between the substantially flat body portion of the device and a surface of the strike material when the device is in use.

14. The animal waste removal device of claim 1, wherein the point located at the terminal end of each of the plurality of extension pieces comprises a first surface and a second surface that each form an angle with respect to an imaginary line running parallel to an edge defining one of the extension pieces, wherein the angle is formed within a range of about ten degrees to about twenty-five degrees.

15. The animal waste removal device of claim 1, wherein the point comprises a plurality of ribs formed on a top side and bottom side of said point to aid in preventing animal waste from falling off said point.

16. The animal waste removal device of claim 1, wherein each of the plurality of extension pieces is defined by at least one square edge so as to aid in preventing wet animal waste from falling in between adjacent extension pieces.

17. The animal waste removal device of claim 1, wherein the device further comprises a proximal end, a distal end, a medial side and a lateral side, wherein the medial side comprises a medial edge and the lateral side comprises a lateral edge, wherein the medial edge and the lateral edge define the medial-lateral limits of the device and wherein said medial edge and said lateral edge are square;
wherein each of the plurality of extension pieces has a length that is between a range of about twenty percent to about sixty percent of a length of the entire device;
wherein the plurality of extension pieces each comprise a width that is between a range of about three millimeters to about eight millimeters;
wherein each of the plurality of extension pieces is defined by at least one square edge so as to aid in preventing wet animal waste from falling in between adjacent extension pieces;
wherein device comprises a gap having a width formed between two adjacent extension pieces, wherein the width is within a range of about two millimeters to about five millimeters;
wherein the width of the gap is within a range of about twenty-five percent to about sixty-seven percent of a width of each of the plurality of extension pieces;
wherein each point is rounded to guide strike material through the gaps of the device to aid in the removal of waste material, to reduce the occurrence of injury to a user and to reduce the chance of the points penetrating, thereby hanging up on, the strike material;
wherein each point has a top side that is beveled and a bottom side that is beveled to reduce friction between the plurality of extension pieces and the strike material, to cause the plurality of extension pieces to flatten out as the device nears a tangential orientation with respect to the strike material;
wherein each point comprises a first surface and a second surface that form an angle with respect to an imaginary line running parallel to one of the square edges defining one of the extension pieces, wherein the angle is formed within a range of about ten degrees to about twenty-five degrees;
wherein each point comprises a plurality of ribs formed on a top side and bottom side of the point to aid in preventing animal waste from falling off said point;
wherein the substantially flat body portion comprises a back edge formed between two adjacent extension pieces at a junction of the gap with an end of the substantially flat body portion for allowing strike material to move through the gap without clogging;
wherein the back edge is beveled;
wherein the device further comprises a wall protruding from the body forming a barrier;
wherein the substantially flat body comprises an upper surface and a lower surface, wherein a plane is defined by the upper surface, and wherein the wall protrudes substantially perpendicular to the plane defined by the upper surface.

18. A method of removing animal waste comprising the steps of:
(a) providing a device having a substantially flat body portion with a plurality of extension pieces extending from the body portion and a point located at a terminal end of each of the plurality of extension pieces;
(b) positioning the device relative to a strike material in preparation for removing animal waste; and
(c) moving the device relative to the animal waste such that the waste is positioned on the plurality of extension pieces.

19. A method of removing animal waste comprising the steps of:
(a) providing a device having a plurality of extension pieces each having a point at its terminal end and a protruding wall acting as a guard;
(b) positioning the device relative to a strike material in preparation for removing animal waste; and
(c) moving the device relative to the animal waste such that the waste is positioned on the plurality of extension pieces.

20. An animal waste removal device comprising:
a body portion;
a means for positioning animal waste on the device; and
a means for maintaining animal waste on the device throughout the removal process.

21. The animal waste removal device of claim 20, wherein the body portion is substantially flat and planar.

22. The animal waste removal device of claim 20, wherein the body portion is curved in an area that is located distally with respect to a midline of the device to form a substantially curved collection area, wherein the curve is in a medial to lateral direction with respect to a top portion of the device.

23. An animal waste removal device comprising:
a body portion; and
a plurality of extension pieces extending from the body portion, wherein each of the plurality of extension pieces comprises a terminal end;
wherein the terminal end of each of the plurality of extension pieces comprises a tapered top surface and a tapered bottom surface to reduce friction between the plurality of extension pieces and a strike material and for positioning the plurality of extension pieces in a substantially flat orientation as the device is moved toward a tangential orientation with respect to the strike material.
